(19) United States
(12) Patent Application Publication
(10) Pub. No.: US 2005/0221046 A1
(43) Pub. Date: Oct. 6, 2005

(54) Sealant material

(75) Inventor: Terry Finerman, Rochester Hills, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/092,531

(22) Filed: Mar. 29, 2005

Related U.S. Application Data
(60) Provisional application No. 60/558,594, filed on Apr. 1, 2004.

(51) Int. Cl. B32B 3/00

(52) U.S. Cl. 428/57

(57) ABSTRACT

A sealant material is provided for sealing an interface between members of an article of manufacture such as an automotive vehicle. In a preferred embodiment, the sealant material has a first portion and a second portion wherein the first portion is adapted for sealing the interface while the second portion provides a surface suitable for use within the article of manufacture.

### PRIORITY CLAIM

The present appliction claims the benefit of U.S. Provisional Application Serial No. 60/558,594 filed Apr. 1, 2004.

### FIELD OF THE INVENTION

The present invention relates to a sealant material for sealing a component of an article of manufacture such as an automotive vehicle.

### BACKGROUND OF THE INVENTION

Sealant materials are often applied to a surface for sealing or for otherwise covering the surface, including any joints associated therewith. There presently exist a vast number of sealant materials that serve these purposes for different articles of manufacture. However, in certain circumstances, it may be desirable for sealant materials to serve other additional purposes depending on the components or articles of manufacture to which the sealant materials are applied.

For example, in some industries, such as the furniture, appliance or automotive industries, joints are typically part of a show surface, and are thus visible to a user or consumer. Accordingly, one desirable characteristic for a sealant material covering a joint is to provide a generally smooth or continuously or controlled patterned surface that is cosmetically pleasing. If colorant is not already included in the sealant, but a color is desirable, preferably the sealant material is paintable.

As another example, it may be desirable for a sealant material to be compatible with other components of an article of manufacture. For instance, it may be desirable for a sealant material to provide a relatively smooth and consistent surface such that a component of an article of manufacture may be contacted with that sealant material without surface inconsistencies of the sealant material showing or reading through the component.

Certain assembly operations in the aforenoted industries and others, require that a sealant material be heated along with the article to which it is applied. For instance, some priming or painting operations are conducted at elevated temperatures. Thus, another desirable trait for certain sealants is that they exhibit attractive temperature response characteristics for a desired application (e.g., a sealant material preferably does not exhibit random oozing, bubbling, rippling, or the like).

### SUMMARY OF THE INVENTION

Accordingly, the present invention provides a seal for an article of manufacture such as an automotive vehicle. Typically, the article of manufacture with include a first member adjoining a second member for forming an interface between the members. As an example, a first panel and a second panel of an automotive vehicle may form a roof ditch and the panels may overlap within the roof ditch for forming an interface between the panels. The seal includes a first portion and a second portion wherein, upon heating, the first portion is configured to flow to a greater degree than the second portion. Preferably, upon heating, the second portion maintains a surface (e.g., a smooth surface) suitable for use within the article of manufacture. For example, in an automotive vehicle, the a trim piece may be placed in overlaying relation with the surface.

### BRIEF DESCRIPTION OF THE DRAWINGS

The features and inventive aspects of the present invention will become more apparent upon reading the following detailed description, claims, and drawings, of which the following is a brief description:

FIG. 1 illustrates a perspective view of an exemplary sealant material formed according to the present invention;

FIG. 2 illustrates a sectional view of the exemplary sealant material of FIG. 1 applied to an article of manufacture, but prior to activation of the material;

FIG. 3 illustrates a sectional view of the exemplary sealant material of FIG. 1 after activation;

FIG. 4 illustrates a sectional view of an alternative exemplary sealant material of the present invention;

FIG. 5 illustrates a sectional view of another alternative exemplary sealant material of the present invention;

FIG. 6 illustrates a sectional view of yet another alternative exemplary sealant material of the present invention; and

FIG. 7 illustrates a sectional view of an additional alternative exemplary application for the sealant material of the present invention.

### DETAILED DESCRIPTION OF THE PREFERRED EMBODIMENT

The present invention is predicated upon the provision of an improved sealant material and articles incorporating the same. The sealant material typically includes a first portion formed of a first material and a second portion formed of a second material.

The first material is typically compositionally different than the second material, although not required. In one preferred embodiment, the first material tends to flow more than the second material upon exposure to an ambient condition such as heat. It is contemplated that the first portion may be situated in a variety of locations relative to the second portion. For example, the first portion and second portion may be side by side and may be integral or non-integral. As another example, the first portion and second portion may be situated with either one of the portions above or atop the other portion. As still another example, the first portion and second portion may be situated with either one of the portions layered upon the other portion.

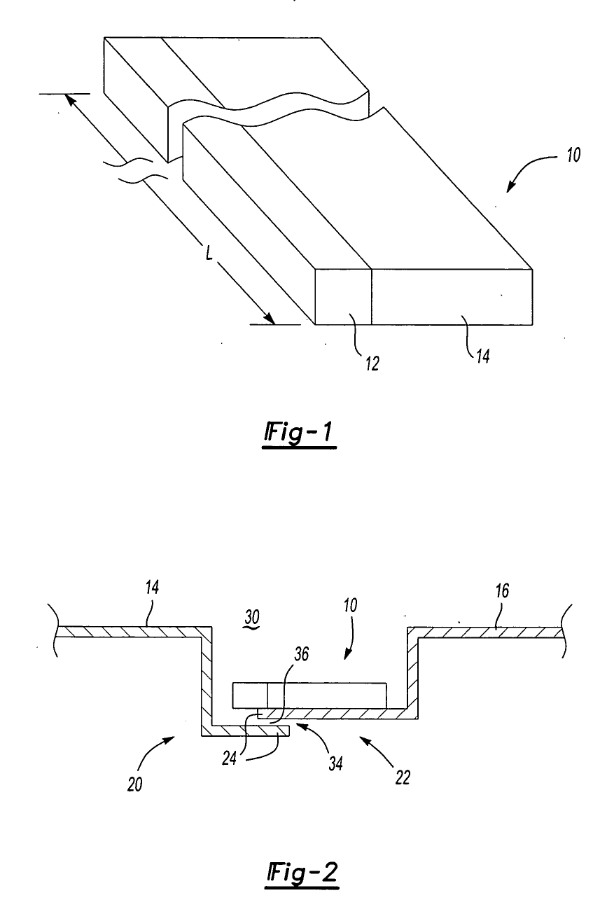

Referring to FIG. 1, there is illustrated one exemplary sealant material 10 formed in accordance with the present invention. As can be seen, the sealant material 10 includes a first portion 12 and a second portion 14. The first portion 12 is formed of a first material and the second portion 14 is formed of a second material different from the first material. As shown, the first portion 12 is attached to (e.g., integral with) the second portion 14.

It is generally contemplated that, the sealant material may be formed in a variety of shapes or configurations. In the embodiment illustrated in FIG. 1, the sealant material 10 is an elongated strip that extends along a length (L) and has a rectangular cross-section perpendicular to that length (L). Both the first portion 12 and the second portion 14 are formed as strips that also extend along the length (L) and both preferably extend along substantially the entire length (L), although not required. The first portion 12 and second portion 14 are illustrated as being side by side relative to each other. Each portion 12, 14 is also shown to also have a substantially rectangular or square cross-section perpendicular to the length (L).

The first portion 12 may be larger or smaller than the second portion 14 depending upon the article to which the sealant material 10 is being applied. In the particular embodiment shown, the first portion 12 has a volume that is less than half the volume of the second portion 14 and more typically less than one third or one quarter of the volume of the second portion 14.

The first portion and second portion of the sealant material of the present invention are typically formed of materials that are compositionally different than each other and which typically have different characteristics, although not required. Preferably, the differences between the materials of the two portions allow the first portion to perform a first function effectively while the second portion performs a second function effectively. For example, the first portion can be formed of a first material that is particularly effective at sound absorption or baffling while the second portion may be formed of a second material that is particularly effective for providing reinforcement to a component to which the sealant material has been applied.

In one preferred embodiment, the first portion and second portion will be activated (e.g., softened, flowable or both) upon exposure to a stimulus such as heat and/or elevated temperatures. Preferably, the first portion is formed of a first material that becomes more flowable upon activation temperature than the second material that forms the second portion. Advantageously, in such an embodiment, this allows the first portion to flow and seal while the second portion experiences less flow and can provide a smooth surface suitable for function such a contacting other components of an article of manufacture (e.g., an automotive vehicle), for being painted, combinations thereof or the like.

When the sealant material is employed for automotive or other applications (e.g., particularly applications where an article is painted, corrosion resistance coated or both), the sealant material or portions thereof are typically activated at an elevated temperature that is typically those experienced during painting, coating (e.g., e-coating) or the like. Thus, the sealant material is typically heated or exposed to a temperature of between about 80° C. and about 325° C., more typically between about 95° C. and about 250° C. even more preferably between about 110° C. and about 180° C. At such elevated temperature, during activation or flow, the viscosity of the material of the first portion typically reaches a lowest value that is less than about half, more typically less than about one quarter and even more typically less than about one eighth the lowest value of viscosity reached by the material of the second portion. For exemplary purposes, a typical lowest value of viscosity of the material of the first portion, at about 100° C. and a shear rate of about 100 s⁻¹, and during activation or flow, is below about 1500 centipoise, more typically below about 500 centipoise, even more typically below about 300 centipoise and still more typically below about 150 centipoise. At about 100° C. and a shear rate of about 100 s⁻¹, and during activation or flow, a lowest value of viscosity reached by the second portion is typically above about 200 centipoise, more typically above about 350 centipoise, even more typically above about 600 centipoise, still more typically above about 1000 centipoise and still even more typically above about 4000 centipoise.

As used herein, the lowest values of viscosity may be achieved for very short periods of time or more extended periods of time. For example, a thermoplastic type material can be heated to a particular temperature and will typically maintain the same viscosity (e.g., lowest value) for an extended period of time as long as it remains at that temperature. In contrast, thermoset materials will, upon heating, typically become flowable and reach a lowest value viscosity only for a short period of time until the material more substantially cures at the elevated temperature thereby raising its viscosity. It is contemplated that the first portion, the second portion or both of the sealant material may be formed of thermoset materials, thermoplastic materials, other materials, combinations thereof or the like.

Differences in viscosity at elevated temperatures, in one embodiment, can be achieved using a variety of techniques. For example, the second portion can maintain a higher viscosity at elevated temperatures, particularly when the first portion and second portion have similar ingredients, by formulating the second portion to have a higher average molecular weight than the average molecular weight of the first portion. In such an embodiment, the material of the second portion typically has an average molecular weight that is 10% higher, more typically 30% higher and even more preferably 50% higher than the average molecular weight of the material that forms the first portion.

As another additional or alternative technique for achieving different viscosities at elevated temperature, different ingredients may be employed in the first portion as opposed to the second portion. For example, and without limitation, an epoxy/ethylene methyl acrylate (EMA) copolymer based blend may be employed as the material for the first portion while an ethylene vinyl acetate copolymer (EVA)/(EMA) copolymer based blend may be employed as the material for the second portion.

As another additional or alternative technique for achieving different viscosities at elevated temperatures, different weight percentages of materials may be employed in the material of the first portion as opposed to the material of the second portion. For instance, the second portion can include a higher weight percentage of material such as a filler or rheology modifier for increasing its viscosity at elevated temperature. As an example, the second portion may include a higher weight percentage of a filler such as a clay, a nanoclay, exfoliated clay or mineral (e.g., garamite, montmorillonite, others mentioned herein, combinations thereof or the like), which will tend to increase the viscosity of the second portion at elevated temperatures. In such an embodiment, the second portion will typically include at least about 0.01% or 0.1% or less, more typically at least about 1%, even more typically at least about 3% and still more typically at least about 7%, 30% or 70% more by weight of the viscosity increasing material. For example, if the first portion includes 0.0% by weight of viscosity increasing material, the second portion could include 3% more by weight of viscosity increasing material such that the second portion includes 3% by weight of viscosity increasing material. It is also contemplated that the second portion may include such a viscosity increasing material while the first portion is substantially without such a viscosity increasing material.

As still another additional or alternative technique for achieving different viscosities at elevated temperatures different weight percentages of curing agents or curing agent accelerators may be used in the second portion as compared to the first. In such an embodiment, the second portion will typically include at least about 0.01% or 0.1% or less, more typically at least about 1%, even more typically at least about 3% and still more typically at least about 7%, 30% or 70% more by weight of the curing agent or curing agent accelerator. For example, if the first portion includes 0.0% by weight of curing agent or curing agent accelerator, the second portion could include 3% more by weight of curing agent or curing agent accelerator such that the second portion includes 3% by weight curing agent or curing agent accelerator. It is also contemplated that the second portion may include a curing agent accelerator while the first portion is substantially without a curing agent accelerator. As another alternative, different or additional agent or accelerators may be employed in the different portions relativel to each other.

Generally, it is contemplated that a variety of materials can be employed in the first portion or the second portion. Thus, the preferred materials discussed herein should not be considered limiting unless otherwise stated. Moreover, for the various potential ingredients are discussed herein, it is contemplated that such ingredients may be employed in the first portion, the second portion or both of the sealant material even though they may only be discussed as suitable for the sealant material generally. It is also contemplated that the various techniques for achieving different viscosities may be used alone or in combination with each other. Furthermore, it is contemplated that the sealant material may have additional portion (e.g., third and forth portions) that are designed to have similar or different melt viscosities relative to the first and second portion.

Epoxy Materials

Epoxy materials can be particularly suitable for the sealant material of the present invention. Epoxy resin is used herein to mean any of the conventional dimeric, oligomeric or polymeric epoxy materials containing at least one epoxy functional group. The polymer based materials may be epoxy containing materials having one or more oxirane rings polymerizable by a ring opening reaction. In preferred embodiments, the sealant material includes up to about 80% of an epoxy resin. More preferably, the sealant includes between about 10% and 50% by weight of epoxy containing materials.

The epoxy containing materials may be aliphatic, cycloaliphatic, aromatic or the like. The epoxy may be supplied as a solid (e.g., as pellets, chunks, pieces or the like) or a liquid (e.g., an epoxy resin) or both. The epoxy may be blended with one or more ethylene copolymers or terpolymers that may possess an alpha-olefin. As a copolymer or terpolymer, the polymer is composed of two or three different monomers, i.e., small molecules with high chemical reactivity that are capable of linking up with similar molecules. Preferably, an epoxy resin is added to the sealant material to increase the flow properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive.

Epoxy/Elastomer

One or more of the epoxy containing materials may be provided to the sealant material as an epoxy/elastomer hybrid, e.g., a blend, copolymer or adduct that has been previously fabricated. The epoxy/elastomer hybrid, if included, may be included in an amount of up to about 90% by weight of the sealant material. Typically, the epoxy/elastomer hybrid is approximately 1 to 50% and more typically is approximately 5 to 20% by weight of the sealant material.

In turn, the hybrid itself generally includes about 1:5 to 5:1 parts of epoxy to elastomer, and more preferably about 1:3 to 3:1 parts or epoxy to elastomer. In one preferred embodiment, the epoxy/elastomer hybrid preferably includes approximately 40 to 80% of an epoxy resin (such as disclosed in the above), and about 20 to 60% of an elastomer compound. The elastomer compound may be any suitable art disclosed thermoplastic elastomer, thermosetting elastomer or a mixture thereof. Exemplary elastomers include, without limitation natural rubber, styrenebutadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed.

The epoxy/elastomer hybrid, when added to the sealant material, preferably is added to modify structural properties of the sealant material such as strength, toughness, stiffness, flexural modulus, or the like. Additionally, the epoxy/elastomer hybrid may be selected to render the sealant material more compatible with coatings such as water-borne paint or primer system or other conventional coatings.

Rheology Modifier

The sealant material can also include one or more materials for controlling the rheological characteristics of the sealant material over a range of temperatures (e.g., up to about 250° C. or greater).

In one embodiment, any suitable art-disclosed rheology modifier may be used, and thus the rheology modifier may be organic or inorganic, liquid or solid, or otherwise. In a particularly preferred embodiment, the rheology modifier is a polymer, and more preferably one based upon an olefinic (e.g., an ethylene, a butylenes, a propylene or the like), a styrenic (e.g., a styrene-butadiene-containing rubber), an acrylic or an unsaturated carboxylic acid or its ester (such as acrylates, methacrylates or mixtures thereof; e.g., ethylene methyl acrylate polymer) or acetates (e.g., EVA). The rheology modifier may be provided in a generally homogeneous state or suitable compounded with other ingredients. It is also contemplated that the various clays, minerals or other materials discussed in relation to fillers below can be employed to modify rheology of the sealant material.

Blowing Agent

Optionally, one or more blowing agents may be added to the sealant material, although for some applications the sealant material will be substantially or entirely devoid of blowing agent or blowing agent accelerator. When used, the blowing agent typically produces inert gasses that form as desired an open and/or closed cellular structure within the sealant material. In this manner, it may be possible to lower the density of articles fabricated from the material. In addition, the material expansion helps to improve sealing or wetting capability.

The blowing agent may include one or more nitrogen containing groups such as amides, amines and the like. Examples of suitable blowing agents include azodicarbonamide, dinitrosopentamethylenetetramine, azodicarbonamide, dinitrosopentamethylenetetramine, 4,4ᵢ-oxy-bis-(benzenesulphonylhydrazide), trihydrazinotriazine and N,Nᵢ-dimethyl-N,Nᵢ-dinitrosoterephthalamide. In a highly preferred embodiment, modified and unmodified azocarbonamides may be supplied to the material 10 in particle form having particles sizes of, for example, 120 and 180 microns. Advantageously, the azocarbonamides can assist the sealant material in leveling itself (i.e., forming a surface or maintaining the surface 24 in a substantially flat condition).

An accelerator for the blowing agents may also be provided in the sealant material. Various accelerators may be used to increase the rate at which the blowing agents form inert gasses. One preferred blowing agent accelerator is a metal salt, or is an oxide, e.g. a metal oxide, such as zinc oxide.

Amounts of blowing agents and blowing agent accelerators can vary widely within the sealant material depending upon the type of cellular structure desired, the desired amount of expansion of the sealant material, the desired rate of expansion and the like. Exemplary ranges for the amounts of blowing agents and blowing agent accelerators in the sealant material range from about 0% by weight to about 5% by weight and are preferably in the sealant material in fractions of weight percentages.

Curing Agent

One or more curing agents and/or curing agent accelerators may be added to the sealant material. Amounts of curing agents and curing agent accelerators can, like the blowing agents, vary widely within the sealant material depending upon the type of cellular structure desired, the desired amount of expansion of the sealant material, the desired rate of expansion, the desired structural properties of the sealant material and the like. Exemplary ranges for the curing agents or curing agent accelerators present in the sealant material range from about 0% by weight to about 7% by weight.

Preferably, the curing agents assist the sealant material in curing by crosslinking of the polymers, epoxy resins (e.g., by reacting in stoichiometrically excess amounts of curing agent with the epoxide groups on the resins) or both. It is also preferable for the curing agents to assist in thermosetting the sealant material. Useful classes of curing agents are materials selected from aliphatic or aromatic amines or their respective adducts, amidoamines, polyamides, cycloaliphatic amines (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines such as triethylenetetramine, diethylenetriamine tetraethylenepentamine, cyanoguanidine and the like. An accelerator for the curing agents (e.g., methylene diphenyl bis urea) may also be provided for preparing the sealant material.

Filler

The sealant material may also include one or more fillers, including but not limited to particulated materials (e.g., powder), beads, microspheres, or the like. Preferably the filled includes a relatively low-density material that is generally non-reactive with the other components present in the sealant material.

Examples of fillers include silica, diatomaceous earth, glass, clay, nanoclay, exfoliated clay, talc, pigments, colorants, glass beads or bubbles, glass, carbon ceramic fibers, antioxidants, and the like. Such fillers, particularly clays, can assist the sealant material in leveling itself during flow of the material. The clays that may be used as fillers may include clays from the kaolinite, illite, chloritem, smecitite or sepiolite groups. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular.

When employed, the fillers in the sealant material can range from 10% to 90% by weight of the sealant material. According to some embodiments, the sealant material may include from about 0% to about 3% by weight, and more preferably slightly less that 1% by weight clays or similar fillers. Powdered (e.g. about 0.01 to about 50, and more preferably about 1 to 25 micron mean particle diameter) mineral type filler can comprise between about 5% and 70% by weight, more preferably about 40% to about 60%, and still more preferably approximately 55% by weight of the sealant material. In one highly preferred embodiment the sealant material may contain approximately 7% by weight mica.

Other Additives

Other additives, agents or performance modifiers may also be included in the sealant material as desired, including but not limited to a UV resistant agent, a flame retardant, an impact modifier, a heat stabilizer, a colorant, a processing aid, a lubricant, a reinforcement (e.g., chopped or continuous glass, ceramic, aramid, or carbon fiber or the like).

Other polymers may also be incorporated into the sealant material, e.g., by copolymerization, by blending, or otherwise. For example, without limitation, other polymers that might be appropriately incorporated into the sealant material include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, or mixtures thereof. Other potential polymeric materials may be or may include include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methylmethacrylate), poly(vinyl acetate), poly(vinylidene chloride), polytetrafluoroethylene, polyisoprene, polyacrylamide, polyacrylic acid, polymethacrylate, and polyacetals.

### EXAMPLES

For illustrative purposes, tables A and B have been provided to show exemplary formulations having approximate weight percentages of ingredients for potential materials of the first portion and second portion of the sealant material of the present invention. Table A shows a formulation for a material that is considered particularly suitable for the first portion of the sealant material and table B shows a formulation particularly suitable for a material that is considered to be particularly suitable for the second portion of the sealant material.

TABLE A

| Ingredients | Weight Percentages |
|---|---|
| Epoxy/Rubber Adduct | 14% |
| Epoxy Resin | 19% |
| Ethylene copolymer (EVA, EMA, | 16% |
| EBA...) or terpolymer | |
| Calcium carbonate (filler) | 50% |
| Epoxy curatives | 1% |
| Colorant | <1% |

TABLE B

| Ingredients | Weight Percentages |
|---|---|
| Epoxy/Rubber Adduct | 14% |
| Epoxy Resin | 19% |
| Ethylene copolymer (EVA, EMA, | 16% |
| Calcium carbonate (filler) | 48% |
| Clay (e.g., montmorillonite clay) | 1% |
| Epoxy curatives | 1% |
| Epoxy cure accelerator | >0.1% |
| Colorant | <1% |

While a summation of the weight percentages of the above ingredients does not yield 100% exactly, it should be understood that the weight percentage of calcium carbonate filler may be raised or lowered to accommodate the amounts of colorant, clay, cure accelerator or th like.

Formation

The sealant material of the present invention may be formed using several different techniques. Preferably, the first portion of the sealant material has a substantially homogeneous composition within itself and the second portion of the sealant material has a substantially homogeneous composition within itself. However, it is contemplated that various combining techniques may be used to increase or decrease the concentration of certain components in certain locations of the portions of the sealant material or the sealant material itself. Typically, the components or ingredients of the material of the first portion of the sealant material are mixed together separately from the components or ingredients of the material of the second portion of the sealant material.

According to one embodiment, the materials of either of the portions of the sealant material can be formed by supplying the components of the material in solid form such as pellets, chunks and the like, in liquid form or a combination thereof. The components are typically combined in one or more containers such as large bins or other containers. Preferably, the containers can be used to intermix the components by rotating or otherwise moving the container. Thereafter, heat, pressure or a combination thereof may be applied to soften or liquidize the components such that the components can be intermixed by stirring or otherwise into a single homogenous composition.

According to another embodiment, the materials of either of the portions of the sealant material may be formed by heating one or more of the components that is generally easier to soften or liquidize such as the polymer based materials to induce those components into a mixable state. Thereafter, the remaining components may then be intermixed with the softened components.

For mixing, a variety of mixers or other devices may be employed. For example, such devices can include, without limitation, an internal mixer, a kneader, a mill, a single or twin screw extruder, a planetary mixer, a compounding extruder, combinations thereof or the like.

Once the ingredients of the materials of the respective portions have been combined, the portions are typically attached to each other or at least located proximate each other.

In one embodiment, the first portion and second portion may be formed (e.g., shaped) separately and then attached to each other. As examples, the first portion and second portion can be separately extruded, molded (e.g., compression or injection molded) or otherwise shaped into a desired configuration. Thereafter, the first portion can be attached to the second portion, for instance, by adhesive securing of one of the portions to the other, mechanical interlocking of one part of one portion into a cavity of the other portion, fastening one portion to the other portion with fasteners, heating a surface of one portion and contacting the surface with the other portion such that the surface adheres to the other portion, combinations thereof or the like.

It is also contemplated that the first portion and second portion may be formed (e.g., shaped) substantially simultaneously into the sealant material. For example, the first and second portion can be co-molded (e.g, two shot molded, compression molded, injection molded, combinations thereof or the like). As another example, the first and second portions may be manually shaped together.

In the embodiment of FIG. 1, the sealant material 10 is formed by co-extruding the first portion 12 and the second portion 14 through one or more opening of a die of an extruder. Advantageously, such co-extrusion can allow substantial control over the cross-sectional shape of the sealant material and the amount of the first portion 12 that is extruded relative to and simultaneously with the second portion 14. Various extruders such as a single screw extruder or a twin screw extruder may be employed to co-extrude the sealant material 10. Typically, the first portion 12, the second portion or both are in a viscoelastic state as they are extruded, although not required.

As shown, the sealant material 10 and the portions thereof are extruded as strips having a rectangular or square cross-section, however, other section shapes (e.g., having an asymmetrical shape about a longitudinal axis, a symmetrical shape about the longitudinal axis, varying shapes along the longitudinal axis, longitudinal channels or passages, or the like) are contemplated as well and may be formed as desired or needed for any chosen application. It may also be possible to co-extrude the sealant material or portions thereof with a strip or wire (e.g., for forming an encapsulated or laminated strip or wire, such as for making an antenna for a communications system). Molded or die-cut articles may also be formed from the sealant material of the present invention.

Application

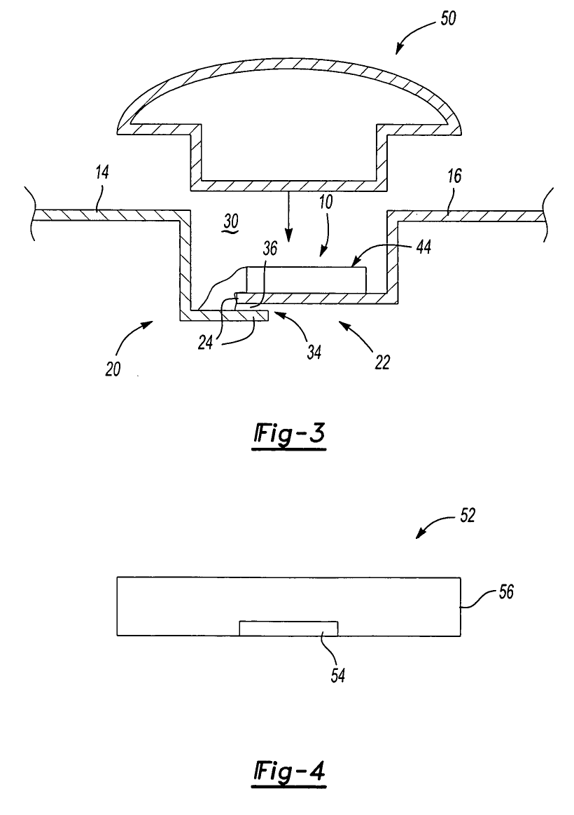

FIGS. 2-3 illustrate an example of the sealant material 10 of the present invention being applied to a substrate 20. The sealant material 10 may be applied to a variety of substrates. However, for exemplary purposes and with no intention of limiting the invention, the material 10 is shown as applied to components 14, 16 (e.g., overlapping panels) for forming a joint 22. The joint 18, as shown, is formed with overlapping ends 24 of the two components 14, 16. In one embodiment, the substrate is formed of a material that includes metal (e.g., steel, aluminum, iron, tin, magnesium, a combination thereof or the like), plastic (e.g., reinforced plastic), a combination thereof or the like.

As discussed, the sealant material 10 may be formed in a variety of shapes, sizes, patterns, thicknesses or the like and may be formed using a variety of forming techniques such as molding, extruding, thermosetting and the like. It is also contemplate that the sealant material or one of the portions thereof may be initially formed in a substantially liquid state wherein the material is shaped by its container or shaped by a substrate to which the material has been applied.

The sealant material may be dry to the touch shortly after it is initially formed to allow easier handling, packaging and the like of the material, however, it is also possible for the material to be wet, tacky or both. As such, the sealant material may be placed adjacent a substrate either manually, automatically or semi-automatically. In one preferred embodiment, the sealant material is extruded directly onto the substrate that is to be sealed by the material.

In the embodiment illustrated in FIG. 2, the sealant material 10 is placed within an opening 30 (e.g., a cavity, ditch or recess) that is formed by the panels 14, 16. In the particular embodiment illustrated, the opening 30 is a roof ditch of an automotive vehicle that is typically formed from body panels of the vehicle. As shown, the overlapping ends 24 of the panels 14, 16 at least partially define the opening 30 and the overlapping ends 24 form an interface 34 between the two panels 14, 16. Typically, the interface 34 will define one or more gaps 36 between the overlapping ends 24 of the panels 14, 16, even though effort is typically expended to minimize such gaps 36 for articles of manufacture such as automotive vehicles.

For sealing a substrate, the sealant material is typically placed upon the substrate with the first portion adjacent to a target location that is to be sealed while the majority (i.e., at least 60%, more typically at least 75% and even more typically at least 90% by volume) of the second portion is further away from the target location than the any part of the first portion, although not required. Generally, it is contemplated that the target location of the substrate may be any type of opening of the substrate such as a cavity, a recess, a gap or the like or may be a flat or contoured portion of the substrate.

In FIG. 2, the target location is the interface 34 and/or the one or more gaps 36 formed by the components 14, 16. As can be seen, the sealant material 10 is placed with the first portion 12 of the sealant material 10 overlaying and/or adjacent the interface 34 and the one or more gaps 36 formed by the interface 34 while the majority of the second portion 14 of the sealant material 10 is located further away from the interface 34 and the one or more gaps 36.

For assisting in locating the sealant, it is contemplated that the first portion may be visibly different from the second portion. For example, the first portion may be a different color, a different shade of a single color, may include different markings or the like than the second portion. Advantageously, such differences can assist an individual or machine in placing the first portion of the sealant material adjacent an interface or other location, which needs to be sealed.

Once the sealant material has been formed in a desired configuration and located, as desired, relative to a substrate, the material may be activated, cured or both to form a seal of a desired configuration. Activation of the sealant material, curing of the material or both may take place in a single stage or multiple stages and may utilize a variety of stimuli to cause activation or curing. Activation, as used herein, generally denotes inducing the sealant material 10 to flow, generally soften, foam, expand, cure or a combination thereof and can be caused by exposure of the sealant material to a variety of stimuli such as heat, light, electricity, pressure, moisture and the like. Curing, as used herein, generally denotes any stiffening, hardening, solidifying or the like of the sealant material and can be caused by exposure to a variety of stimuli such as heat, cooling, light, moisture combinations thereof or the like.

According to one embodiment, the sealant material may be activated prior to application of the sealant material to a substrate such that the sealant material is in a generally flowable state when it is applied to the substrate. In such a situation, curing of the material may occur during or after the time the sealant material is applied to the substrate.

According to another embodiment, the sealant material may undergo a single stage activation, a single stage cure or both. According to still other embodiments, the sealant material may undergo a selective multiple stage activation, a multiple stage cure or both. For example, a portion of the sealant material may be exposed to a stimulus to at least partially cure a portion of the sealant material, e.g. a cure to a predetermined depth (e.g., on the order of about 1 mil to about 2 mm), or a cure in certain regions along or within the mass of material.

Upon activation, typically caused by exposure to heat or other stimulus, the first portion of the sealant material becomes more flowable than the second portion as previously described. Advantageously, this allows the first portion to flow over and seal the target location of the substrate while the second portion can maintain a surface suitable for various uses also previously described.

In the particular embodiment illustrated in FIG. 3, the sealant material 10 is activated by exposure to heat or elevated temperature (e.g., provided as part of a corrosion coating or painting operation of an automotive vehicle). As can be seen, the first portion 12 exhibits a higher degree of flow than the second portion 14 such that the first portion 12 seals the interface 34 and one or more gaps 36. At the same time, the second portion 14 exhibits a lower degree of flow than the first portion 12 such that the second portion can provide a smooth and/or flat surface 44. Advantageously, the smooth surface 44 can allow a trim piece 50 to contact the surface 44 without any substantial read-through of the trim piece 50.

Additionally or alternatively, it is contemplated that a sealed joint prepared in accordance with the present invention can be further coated with a top coat (e.g., a paint) and optionally a primer (between the top coat and the joint), a clear coat (e.g., a polyurethane, an acrylic such as a glycidyl methacrylate (GMA)-based coating, or a mixture thereof) over the top coat, or a combination thereof. Preferably one such coating is a water-based coated, although solvent based coatings may also be used. In one embodiment, the coating includes a two component polyurethane coating. In another embodiment the coating is applied as a powder coating. Preferably an electocoating process is used to apply a coating layer, such as the primer.

As suggested, the sealant material 10 of FIGS. 1-3 is only one shape or configuration of the sealant material of the present invention. For exemplary purposes, FIGS. 4, 5 and 6 have been included to show two of several potential alternative embodiments. It should be understood that each of these alternative embodiments can have any or all of the attributes (i.e., may be formed, applied and may have compositions) as described above.

In FIG. 4, there is illustrated an alternative embodiment of a sealant material 52 of the present invention wherein a first portion 54 of the sealant material 52 is substantially surrounded by a second portion 56 of the sealant material 52. As used herein with reference to FIG. 4 substantially surrounded is intended to mean that at least 50%, more typically at least 65% and even more typically at least 75% or 90% of the surface area of the first portion is contacted by or in opposing relation to surfaces of the second portion. In the particular embodiment of FIG. 4, the first portion 54 is a strip that is located in a cavity in the bottom surface of the second portion 56. The first portion 54 is rectangular in cross-section and is contacted or opposed on three sides by the second portion 56.

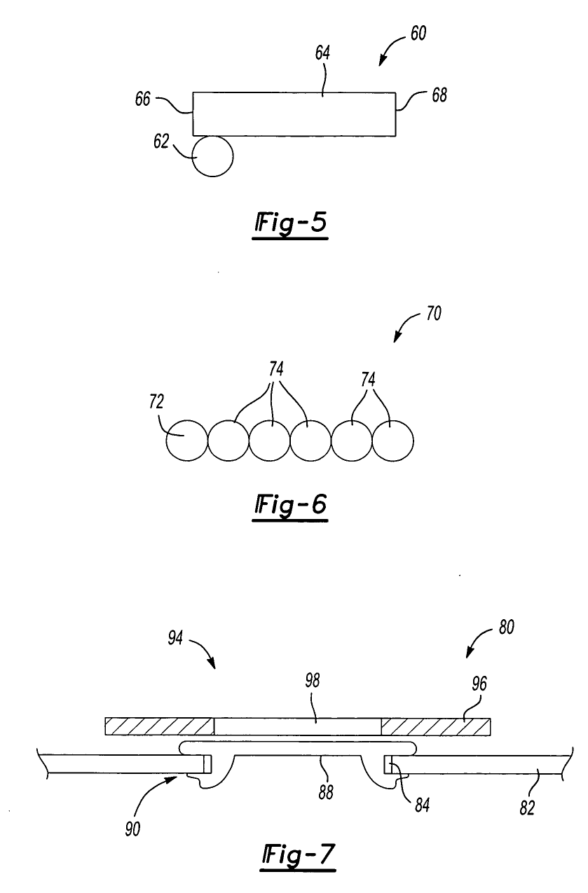

In FIG. 5, there is illustrated an alternative embodiment of a sealant material 60 of the present invention wherein a second portion 64 of the sealant material 60 is substantially similar or identical to the second portion 12 of the sealant material 10 of FIG. 1, however, a first portion 62 of the sealant material 60 is located at least partially or substantially entirely beneath the second portion 64. As shown, the first portion 62 is located closer to a first side 66 of the second portion 64 than to a second side 68 of the second portion 64 that is opposite the first side 66. Moreover, the first portion 62 is substantially circular in cross-section, although the first portion 62 may be shaped as desired.

In FIG. 6, there is illustrated an alternative embodiment of a sealant material 70 wherein the first portion 72 is a strip having a circular cross-section and the second portion 74 is composed of multiple strips having the same cross-section. Of course, the cross-sections of the strips may be shaped as desired for the first and second portions. As shown, the strip of the first portion 72 and the strips of the second portion 74 are side by side with the strip of the first portion 72 located at one side of the sealant material. Of course, there could be plural strip of the first portion and a single strip of the second portion or plural strips of both the first and second portion.

As discussed the sealant material of the present invention may be used in a variety of applications. In FIG. 7, there is illustrated one such alternative application. As a can be seen there is a sealing system 80 that includes a member 82 having an opening 84 (e.g., a through-hole). A second member, shown as a plug 88 is interference fit within the opening 84 thereby creating an interface 90 between the plug 88 and the member 82. A sealant material 94, which includes a first portion 96 and second portion 98, overlays the plug 88 and the member 82 with the first portion 96 adjacent to the interface 90 as described with relation to FIG. 2.

Upon activation, the first portion 96 can flow and seal the interface 90. In a preferred embodiment the first member 82 and the plug 88 provide different types of surfaces for the portions 96, 98 to adhere to. For example, the member 82 and plug 88 may be parts of an automotive vehicle wherein the outer surface of the member 82 is coated with corrosion protection (e.g., e-coat) while the plug 88 may be formed of a galvanealed material (e.g., a galvanealed steel or aluminum). In such an embodiment, it may be desirable to formulate the first portion and second portions of the sealant material to be particularly adept at adhering to the different surfaces (e.g., the second portion should adhere well to the plug while the first portion should adhere well to the member 82).

In addition to the above alternative embodiments, one alternative embodiment contemplates that the first portion and second portion may be such than the second portion becomes more flowable than the first portion. In such an embodiment, the first portion would still become flowable enough to seal the interface or other surface as desired but would be solid enough to act as a constraint for the flow of the second portion.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An article of manufacture; comprising:
a first member;
a second member adjoining said first member forming an interface therebetween;
a sealant over the first member, the second member, the interface or a combination thereof, the sealant material having a first portion and a second portion, wherein:
i) the first portion is located closer to the interface than the second portion; and
ii) upon heating, the first portion becomes more flowable than the second portion for sealing the interface.

2. An article of manufacture as in claim 1 wherein, upon heating to a temperature of between about 100° C. and about 325° C., the first portion reaches a lowest value below about 3000 cP while a lowest value of the viscosity reached by the second portion is above about 3500 cP.

3. An article of manufacture as in claim 1 wherein upon heating to a temperature of between about 140° C. and about 280° C., the first portion reaches a lowest value below about 1200 cP while a lowest value of the viscosity reached by the second portion is above about 5000 cP.

4. An article of manufacture as in claim 1 wherein the first portion is side by side with the second portion and the first portion is integral with second portion.

5. An article of manufacture as in claim 1 wherein, upon heating, the first portion and the second portion are thermoset.

6. An article of manufacture as in claim 1 wherein, the second portion includes at least about 3% by weight more curing agent or curing agent accelerator than the first portion and/or includes at least about 3% by weight more viscosity increasing material than the first portion.

7. An article of manufacture as in claim 1 wherein both the first portion and the second portion include at least one ingredient selected from an EVA, an EMA or an Epoxy Resin and wherein the first portion is located at least partially below the second portion.

8. An article of manufacture as in claim 1 wherein the first member is a plug.

9. An article of manufacture as in claim 8 wherein the first portion is annular and surround the second portion.

10. An assembly of an automotive vehicle, comprising:
a first panel;
a second panel adjoining said first panel of the automotive vehicle for forming an interface between the first and second panels, the interface being at least partially defined by a gap between the first panel and the second panel;
a sealant over at least a portion of the first panel, the second panel and the interface, the sealant material having a first portion and a second portion, wherein:
i) the first portion is substantially smaller than the second portion;
ii) the first portion is located closer to the interface than the second portion; and
iii) upon heating in an e-coat or paint oven, the first portion becomes more flowable than the second portion such that the first portion seals the interface while the second portion maintains an outwardly facing smooth surface.

11. An assembly as in claim 10 wherein, upon heating to a temperature of between about 100° C. and about 325° C., the first portion reaches a lowest value below about 3000 cP while a lowest value of the viscosity reached by the second portion is above about 3500 cP.

12. An assembly as in claim 10 wherein upon heating to a temperature of between about 140° C. and about 280° C., the first portion reaches a lowest value below about 1200 cP while a lowest value of the viscosity reached by the second portion is above about 5000 cP.

13. An assembly as in claim 10 wherein the first portion is side by side with the second portion and the first portion is integral with second portion.

14. An assembly as in claim 10 wherein, upon heating, the first portion and the second portion are thermoset.

15. An assembly as in claim 10 wherein, the second portion includes at least about 3% by weight more curing agent or curing agent accelerator than the first portion and/or includes at least about 3% by weight more viscosity increasing material than the first portion.

16. An assembly as in claim 10 wherein both the first portion and the second portion include at least one ingredient selected from an EVA, an EMA or an Epoxy Resin and wherein the first portion is located at least partially below the second portion.

17. A roof assembly of an automotive vehicle, comprising:
a first panel;
a second panel adjoining said first panel for forming a roof ditch of the automotive vehicle and for forming an interface between the first and second panels, the interface being at least partially defined by a gap between the first panel and the second panel;
a sealant over at least a portion of the first panel, the second panel and the interface, the sealant material having a first portion and a second portion, wherein:
i) the first portion is substantially smaller than the second portion and is formed of a different material than the second portion;
ii) the first portion seals the interface and the second portion maintains an outwardly facing smooth surface;
a trim piece of the automotive vehicle overlaying the smooth surface of the second portion.

18. An assembly as in claim 17 wherein the first portion is side by side with the second portion and the first portion is integral with second portion.

19. An assembly as in claim 18 wherein, upon heating, the first portion and the second portion are thermoset.

20. An assembly as in claim 19 wherein the first and second portion are coated with e-coat.
